(19) United States
(12) Patent Application Publication
(10) Pub. No.: US 2019/0367248 A1
(43) Pub. Date: Dec. 5, 2019

(54) FOAMING CONTAINER HAVING MULTIPLE SPACES AND METHOD FOR MANUFACTURING THE SAME

(71) Applicant: Coswel International LTD., Gangwon-do (KR)

(72) Inventor: Joo Leon KIM, Gangwon-do (KR)

(21) Appl. No.: 16/032,088

(22) Filed: Jul. 11, 2018

(30) Foreign Application Priority Data
May 31, 2018 (KR) 10-2018-0062733

(51) Int. Cl. B65D 81/32; B65D 75/36; B29C 65/18; B29C 65/70; B29C 65/78

(52) U.S. Cl. CPC B65D 81/3288; B65D 75/368; B65D 81/3294; B65D 2543/00953; B29C 65/70; B29C 65/7844; B29C 65/7808; B29C 65/18

(57) ABSTRACT

Disclosed is a molded container having multiple storage spaces, which includes: a molded body having at least two storage spaces and a connection groove to connect the adjacent spaces to each other; a valve unit seated and fixed in the connection groove to allow the adjacent spaces to communicate with each other or to prevent communication therebetween; and a cover member fixed on the molded body to cover and finish the valve unit coupled to the storage spaces and the connection groove. The valve body of the valve unit is coupled on top of the molded body, thereby enabling easy and quick assembly of a final product and enhancing productivity.

### RELATED APPLICATION

This application claims the benefit of priority of Korean Patent Application No. 10-2018-0062733 filed May 31, 2018, the contents of which are incorporated herein by reference in their entirety.

### FIELD AND BACKGROUND OF THE INVENTION

The present invention relates to a molded container having multiple storage spaces and, more particularly, to a molded container having multiple storage spaces that may easily bond an injection valve provided in a section to interconnect the multiple storage spaces, as well as a method for manufacturing the same.

In general, a cosmetic mask pack includes a cosmetic solution filled and packed in a bag in a flat pouch form. The cosmetic mask pack typically demands different components such as vitamin A, vitamin C, etc. in order to maximize and further enhance skin beauty effects. However, when vitamin C is mixed with the cosmetic solution beforehand, this component is easily oxidized by the cosmetic solution and then is degraded, thus considerably decreasing potency thereof.

In order to overcome the above problem, vitamin C and a cosmetic solution are usually separately packed and therefore must be instantly mixed by a consumer when using the same.

For this purpose, multiple storage spaces are formed in a molded container, an injection valve to interconnect the formed storage spaces is mounted and sealed to the container, and cosmetic solutions or powders containing different components are separately charged (received) in the spaces, respectively, followed by finally sealing and packaging the same.

A method of instantly mixing different components received in separate spaces when a user intends to use the same has been developed. An example of this method is disclosed in Korean Patent Registration No. 10-1670774 (Patent Document 1).

A molded container 1 described in Patent Document 2 includes a receiving part 10 and a valve unit 20, as shown in FIG. 1.

The receiving part 10 has a body part 11 including multiple storage spaces 11a, a cover part 13 coupled to the top of the body part 11 to finish the multiple storage spaces 11a. The multiple storage spaces 11a include a first storage space 11b and a second storage space 11c, as shown in FIG. 1.

The cover part 13 is opposed to the body part 11 and finishes and seals up the open storage spaces 11a. The cover part 13 may be coupled to the body part 11 through welding. More particularly, the body part 11 and the cover part 13 are heated and sealed by a welding process, wherein a sealing part 11d is formed in a welded region of the body part 11.

The valve unit 20 is mounted on the sealing part 11d placed between the adjacent storage spaces 11a, that is, the first storage space 11b and the second storage space 11c. The valve unit 20 may enable two storage spaces isolated by the sealing part 11d to be in communication with each other or to prevent communication therebetween. The valve unit usually includes a main body part 21, a support part 23 and a valve member 25.

The main body part 21 is placed at a site on which the sealing part 11d is mounted, receives the valve member 25, connects two storage spaces 11a together, and has a cylindrical shape. At an end of the main body part 21, a receiving groove 21a having a predetermined depth is formed. Further, a pair of flow parts 21b in a pipe form is provided and expands in different directions from each other at an outer periphery of the main body part 21. In particular, the pair of flow parts 21b may expand toward the first storage space 11b and the second storage space 11c, respectively. Further, the pair of flow parts 21b, respectively, may communicate with the receiving groove 21a.

The main body part 21 may include the support part 23 which closely contacts the sealing part 11d while being welded and fixed between the body part 11 and the cover part 13 in order to support and secure the main body part 21.

The valve member 25 is rotatably fitted into the receiving groove 21a of the main body part 21 to selectively open or close the flow part 21b. The valve member 25 includes a base part 25a, which is fitted into the receiving groove 21a and has a connection hole 25a-1 at a specific position, wherein the base part 25a can communicate with the flow part 21b at the specific position; and a handle part 25b integrated at an end of the base part 25a while protruding from the same. The handle part 25b is a portion operable by a user in order to rotate the valve member 25.

Meanwhile, the sealing part 11d between the first storage space 11b and the second storage space 11c in the body part 11 may further have a coupling hole 11e in which the main body part 21 is fitted and coupled. Further, fitting holes are formed on lateral sides facing each other in the first storage space 11b and the second storage space 11c, in which the flow part 21b of the main body part 21 is fitted and connected. Accordingly, when the valve unit 20 is coupled to the body part 11, the pair of flow parts 21b is inserted in the fitting holes present in the first storage space 11b and the second storage space 11c, respectively, while fitting and coupling the main body part 21 therein, thereby protruding the flow parts into the first storage space 11b and the second storage space 11b, as shown in FIG. 3.

The conventional molded container 1 is assembled by coupling the main body part 21 in the body part 11, welding the cover part 13 thereto, and fitting the valve member 25 into the main body part 21.

At first, when the main body part 21 is coupled to the body part 11, the other end of the main body part 21 (the bottom portion in FIG. 3) is fitted into the coupling hole 11e in the body part 11, while a pair of flow parts 21b in the main body part 21 should be inserted and fixed in the fitting holes formed in the first storage space 11b and the second storage space 11c, respectively. However, since the pair of flow parts 21b is generally formed to have a size larger than a distance between the fitting holes in the first storage space lib and the second storage space 11c, it becomes quite difficult to insert a pair of flow parts 21b in fitting holes while fitting the other end of the main body part 21 in the coupling hole 11e.

### Prior Art Document

Patent Document (Patent Document 1) Korean Patent Registration No. 10-1670774

### SUMMARY OF THE INVENTION

The present invention has been proposed to solve the problems described above, and an object of the present invention is to provide a molded container having multiple storage spaces, enabling easy and quick assembly of a final product and thus enhancing productivity, as well as a method for manufacturing the same.

In order to accomplish the above purpose, according to the present invention, there is provided a molded container which includes: a capsule body having at least two storage spaces and a molded connection groove to connect the storage spaces adjacent to each other; a valve unit seated and fixed in the connection groove to allow the adjacent storage spaces to communicate with each other or to prevent the communication; and a cover member fixed on the capsule body to cover and finish the valve unit coupled to the storage spaces and the connection groove.

Further, the valve unit may include: a valve body that has a bottom surface in a shape corresponding to the connection groove, a flat top surface, a connection hole passing through both lateral sides to allow communication between the adjacent storage spaces, and a fitting groove to communicate with the connection hole at the bottom; and a valve having a communication hole rotatably fitted into the fitting groove to block the connection hole or allow communication of the same.

Further, the valve body may further include a pipe type member provided at both peripheries of the connection hole.

Further, the pipe type member may be integrated with the valve body or may be separately provided and then assembled with the valve body later.

Further, the cover member may have an opening to take contents out of the storage spaces and further include a sticker to cover and close the opening.

Further, the present invention provides a method for manufacturing a molded container, which includes: (a) preparing a pre-molded valve unit, a cover member and a plate member; (b) introducing the plate member into a metal mold to form a molded body after step (a); (c) punching a connection groove molded in the molded body formed in step (b) to form a coupling hole, into which the valve unit is fitted; (d) seating and coupling the valve unit in the connection groove of the molded body having the coupling hole formed in step (c); (e) filling multiple storage spaces formed in the molded body coupled with the valve unit in step (d) with different contents; (f) when the storage spaces of the molded body are filled with the contents in step (e), welding the cover member on top of the molded body to close and seal the storage spaces; (g) cutting the peripheries of the storage spaces except for a part of the peripheries of the storage spaces to prepare a product after step (e); and (h) fitting a handle part into the valve member to assemble the container after step (g).

Further, step (d) may include: seating a valve by seating the valve body in the connection groove of the molded body molded in step (b) and step (c), wherein a part of the valve body is fitted into the coupling hole formed by punching the connection groove; and coupling the valve by welding (or sealing) the valve body seated in the connection groove through thermal or ultrasonic welding. According to the present invention, the valve body of the valve unit is coupled on top of the molded body, so as to easily and quickly assemble a final product, thereby enhancing productivity.

### BRIEF DESCRIPTION OF THE SEVERAL VIEWS OF THE DRAWINGS

FIG. 1 is an exploded perspective view illustrating a conventional molded container;

FIG. 2 is another exploded perspective view illustrating a switch member of the molded container shown in FIG. 1;

FIG. 3 is a cross-sectional view illustrating a coupling condition of the switch member of the molded container shown in FIG. 1;

FIG. 4 is an exploded perspective view illustrating a molded container having multiple storage spaces according to a first embodiment of the present invention;

FIG. 5 is an exploded bottom perspective view illustrating a valve unit of the molded container shown in FIG. 4;

FIG. 6 is a perspective view illustrating a molded body of the molded container shown in FIG. 4;

FIG. 7 is a perspective view of prominent parts illustrating a minimum part of the molded body to which the valve body is attached;

FIG. 8 is a cross-sectional view of line A-A in FIG. 6;

FIG. 8 is a cross-sectional view of line B-B in FIG. 6;

FIG. 10 is cross-sectional views illustrating conditions of the valve unit in the molded container before and after using the same; and

FIG. 11 is a flow diagram illustrating a method for manufacturing a molded container having multiple storage spaces according to an embodiment of the present invention.

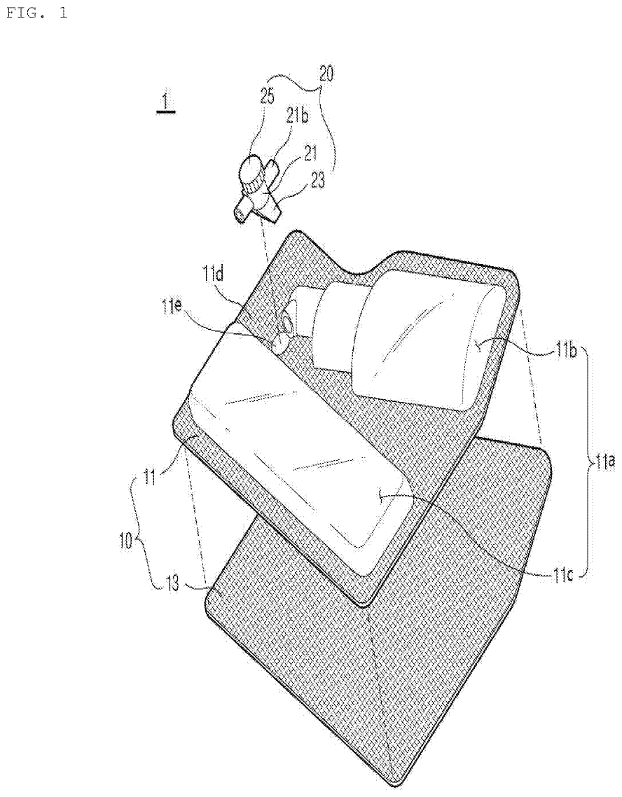

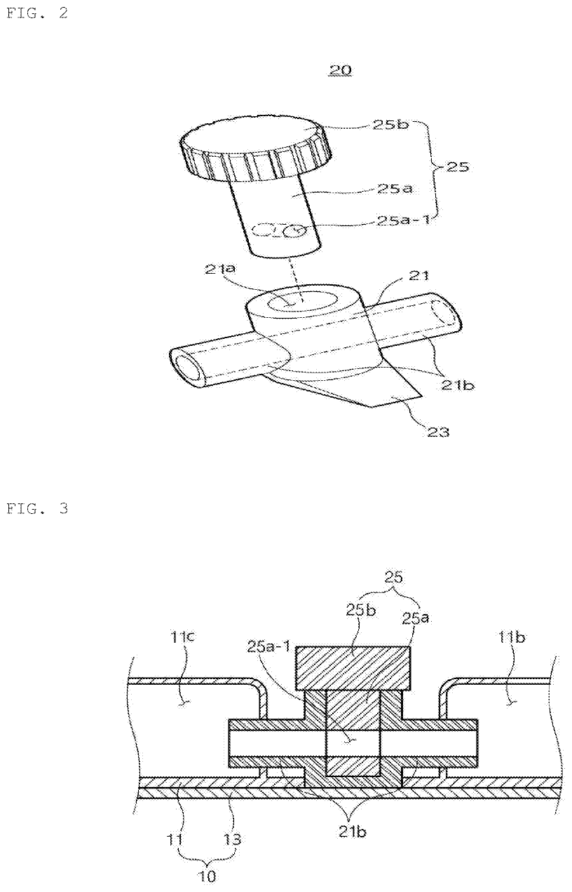

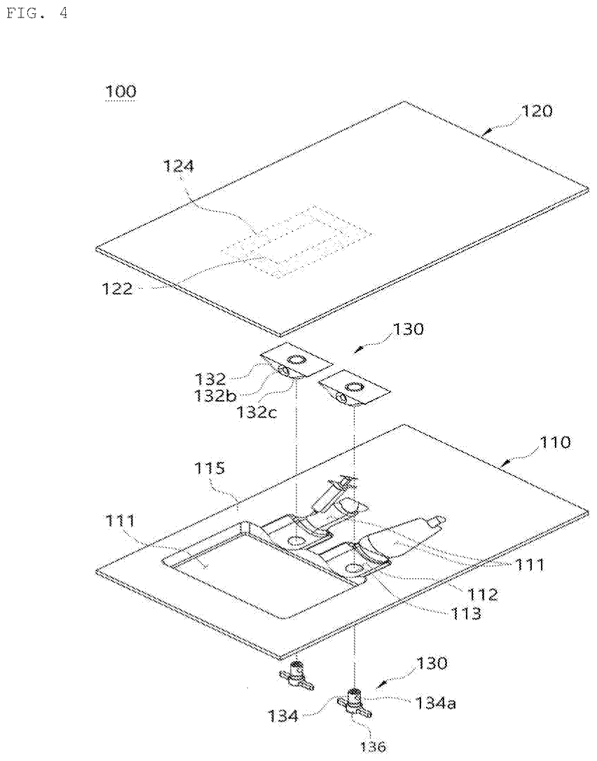

### DESCRIPTION OF SPECIFIC EMBODIMENTS OF THE INVENTION

The terms and/or words used in the detailed description and claims of the present application are not particularly limited to meanings in a commonly-used dictionary but should be interpreted as meanings and/or concepts coincident with the technical spirit of the present invention, on the basis of a principle that “an inventor may suitably define the concept of terminologies in order to stipulate their invention by means of the most preferred way”.

Further, configurations described in the embodiments and illustrated in the drawings are only preferred embodiments of the present invention and do not represent the full technical scope of the present invention. Therefore, it will be understood that various equivalents and modifications capable of replacing the above embodiments may be possible at the time of filing the present application.

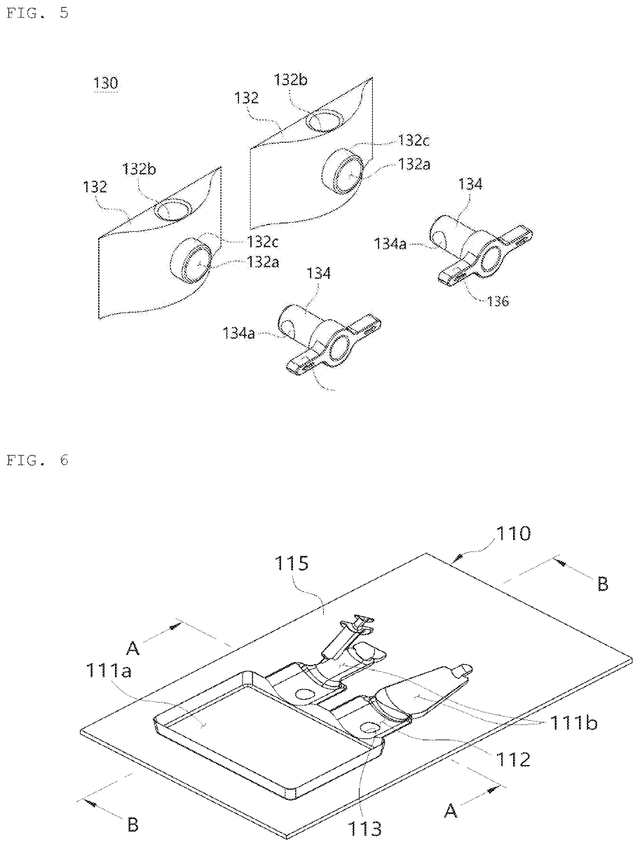

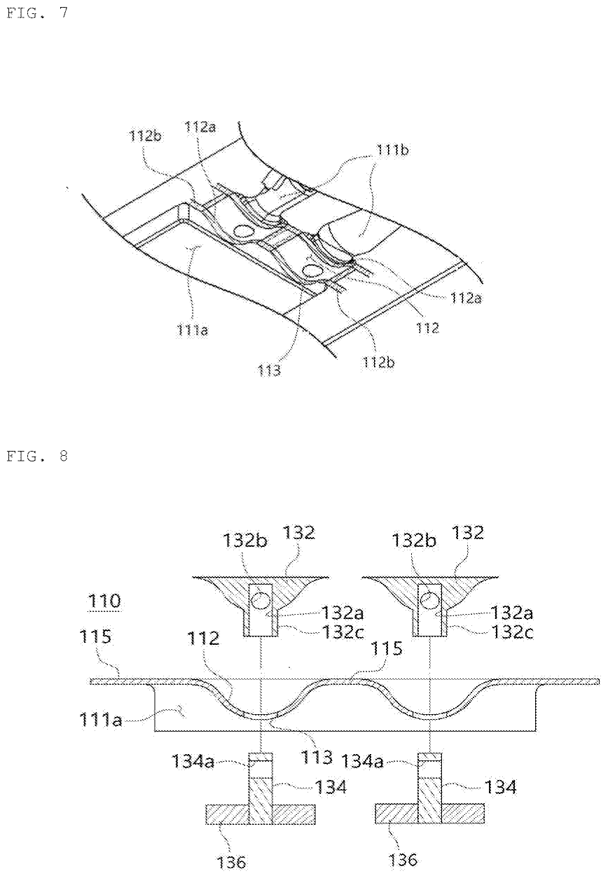

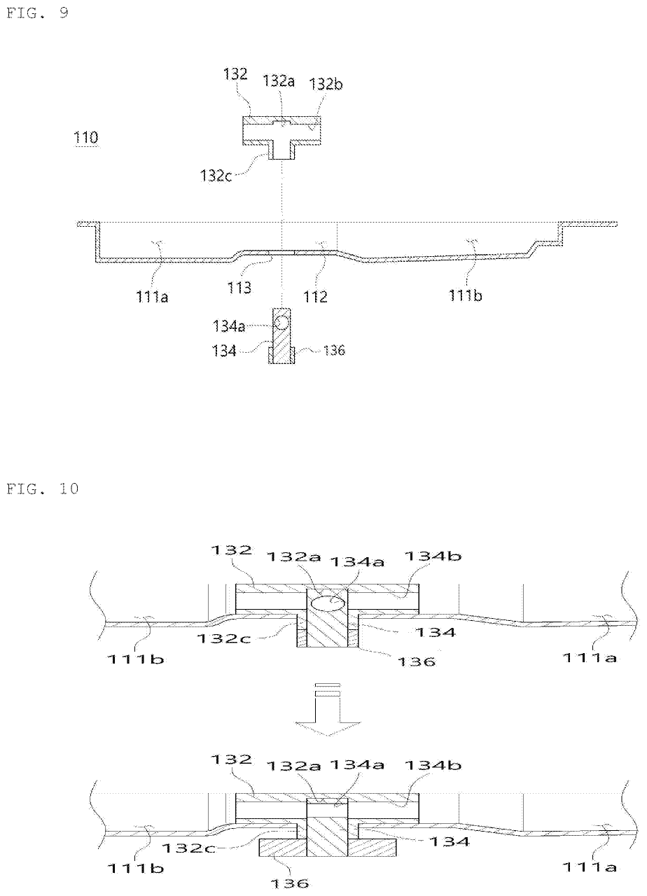

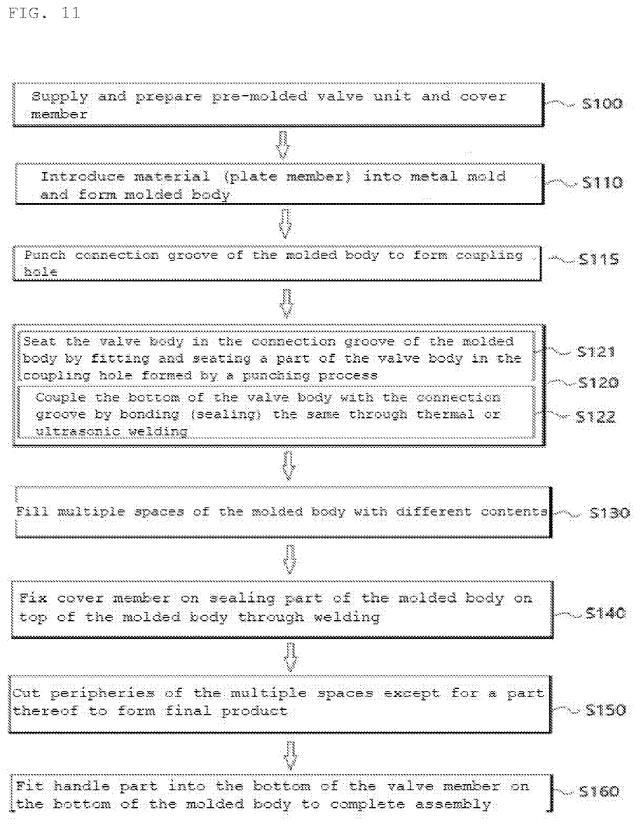

FIG. 4 is an exploded perspective view illustrating a molded container having multiple storage spaces according to a first embodiment of the present invention; and FIG. 5 is an exploded bottom perspective view illustrating a valve unit of the molded container shown in FIG. 4. FIG. 6 is a perspective view illustrating a molded body of the molded container shown in FIG. 4; and FIG. 7 is a perspective view of prominent parts illustrating a minimum part of the molded body to which the valve body is attached. FIG. 8 is a cross-sectional view of line A-A in FIG. 6; and FIG. 9 is a cross-sectional view of line B-B in FIG. 6. FIG. 10 is cross-sectional views illustrating conditions of the valve unit in the molded container before and after using the same.

Referring to FIG. 4 to FIG. 10, the molded container 100 having multiple storage spaces according to the first embodiment of the present invention is configured to receive different contents therein, and may include a molded body 110, a valve unit 130 and a cover member 120.

The molded body 110 may have multiple storage spaces to receive the contents. Herein, the molded body 110 may have a plate shape. Therefore, the multiple storage spaces 111 may be formed by processing the plate type member into a depressed body shape having open top in a molding machine through heat forming, non-heat forming, press forming, vacuum forming, vacuum press forming, and the like.

Further, the molded body may be formed by heating the plate type member then pressing the same. In this regard, the molded body 110 may be formed using any one of polyethylene (PE), polypropylene (PP), polyvinyl chloride (PVC), polycarbonate (PC), metal, etc. Further, the molded body 110 may be formed using polyvinyl chloride with aluminum-coated surface.

Preferably, the cover member 120 and the valve unit 130 described below may also be formed using the same material used for the molded body 110, so as to be coupled with the molded body 110 by a thermal or ultrasonic welding process.

The multiple storage spaces 111 may be formed by coupling the cover member 120 to the top face of the molded body 110 to finish the molded body. Accordingly, the molded body 110 may have a sealing part 115 for coupling the cover member 120 to the molded body through thermal or ultrasonic welding, in order to seal the multiple storage spaces 111.

When coupling and fixing the cover member 120 to the molded body 110 through welding, the sealing part 115 may be a surface region of the molded body 110, on which the cover member 120 is welded. That is, the sealing part 115 may be formed on a whole area except for a region on which the storage spaces 111 are formed, without being limited thereto. In fact, the sealing part may be formed in an efficient shape such that the sealing part can be coupled between the molded body 110 and the cover member 120 and may be sealed between the storage spaces 111, along a predetermined route.

The cover member 120 may be formed using a plate member, so as to be closely welded to the sealing part 115 provided in the molded body 110.

The molded body 110 may include two or more storage spaces 111, and at least one valve unit 130 may be provided. Referring to the drawings, three storage spaces 111 and two valve units 130 are illustrated. However, according to embodiments of the present invention, a molded container 100 provided with two storage spaces 111 and one valve unit 130 will be described below. The storage spaces 111 described herein are formed in a molding manner.

The sealing part 115 partitioning the storage spaces 111 in the molded body 110 may include a connection groove 112 to connect adjacent storage spaces 111 in order to move contents of a storage space 111 to another storage space 111. The connection groove 112 has a smaller depth than that of the storage space 111, and may be configured to move contents of a storage space 111 to another storage space 111 when tilting the molded body 110.

Hereinafter, as shown in FIG. 5, on the basis of the connection groove 112, the storage space 111 is divided into a first storage space 111a and a second storage space 111b based on the connection groove 112, so as to be interconnected by the connection groove 112. These storage spaces will be concretely described below.

The first storage space 111a may have a greater depth than that of the second storage space 111b. That is, the bottom of the second storage space 111b may be formed to gradually increase a depth toward the first storage space 111a to thus incline downward to the first storage space 111a. The purpose of this is to easily move the contents of the second storage space 111b to the first storage space 111a.

The connection groove 112 may include a coupling hole 113 in which the valve body 132 of the valve unit 130 described below is coupled.

The valve unit 130 is seated and coupled in the connection groove 112, serves to communicate adjacent storage spaces to each other, that is, the first storage space 111a and the second storage space 111b or to prevent communication therebetween, and includes a valve body 132 and a valve member 134.

The valve body 132 may have the bottom formed in a shape corresponding to the connection groove 112 and the top formed in a plane shape. If both sides in a plane shape refer to lateral sides, the valve body 132 may include a connection hole 132b passing through the lateral sides of the valve body 132. The valve body 132 may further include a fitting groove 132a which extends upward and is connected to the connection hole 132b, and into which the valve member 134 described below is fitted.

The valve body 132 may include a coupling protrusion 132c protruded downward at the periphery of the fitting groove 132a so as to be fitted into the coupling hole 113 of the connection groove 112. The coupling protrusion 132c may serve to secure a coupling position of the valve body 132 such that the top face of the molded body 110 and the top face of the valve body 132 are kept under the same planar state after coupling the valve body 132 to the connection groove 112.

The valve body 132 is formed by protruding a pipe type member (not shown) at peripheries of both ends of the connection hole 132b. The pipe type member (not shown) may be formed separately and attached to the peripheries of both ends of the connection hole 132b or, otherwise, may be integrated with the peripheries of both ends of the connection hole 132b.

In order to seat and couple the valve body 132 to the connection groove 112, a thermal or ultrasonic welding process may be used. That is, the bottom of the valve body 132 is coupled to the top face of the connection groove 112 by a thermal or ultrasonic welding process while surface-contacting the same. A periphery of the valve body 132 may be coupled to the periphery of the connection groove 112 by an alternative welding member.

The valve member 134 may be fitted in and coupled to the fitting groove 132a of the valve body 132, wherein the valve member is rotatable in the fitting groove 132a. The valve member 134 may be forcibly fitted into the fitting groove 132a in order to complete sealing between the fitting groove 132a and the valve member 134.

The valve member 134 may include a communication hole 134a, which can be in communication with the connection hole 132b of the valve body 132, so that the valve member fitted into the fitting groove 132a may rotate to block the connection hole 132b or release the blocking.

The connection hole 132b of the valve body 132 may have a smaller diameter than that of the valve member 134, in order to block the connection hole 132b by the valve member 134.

The communication hole 134a of the valve member 134 may have a size equal to or smaller than that of the connection hole 132b, in order to prevent contents of the storage space 111 from leaking between the communication hole 134a and the connection hole 132b when the contents move via the connection hole 132b and pass through the communication hole 134a.

Herein, the valve member 134 may further include a handle part 136 coupled to the bottom of the valve member 134, which can be held and rotated by a user, so as to operate the valve unit 130.

Meanwhile, the cover member 120 may have an opening 122 at a site corresponding to the storage space 111, in order to easily take the contents out of the storage space 111 while preventing the same from flowing in other directions, when outputting the contents. The opening 122 may be closed by an alternative sticker 124. More particularly, the sticker 124 may be formed with a larger size than that of the opening 122 to completely cover the opening 122, and may be attached around the periphery of the opening 122 so as to be easily removed when a user pulls on a tip of the sticker 124.

With regard to the molded container having the storage space with such technical configuration as described above according to the embodiments of the present invention, functions of the molded container will be described as follows.

First, the contents of the first storage space 111a may refer to first contents comprising solid components, while the contents of the second storage space 111b may refer to second contents comprising liquid components.

Further, an initial condition of the molded container according to the present invention may be a state wherein the valve unit 130 provided between the first storage space 111a and the second storage space 111b blocks a passage of the connection groove 112 connecting the first storage space 111a and the second storage space 111b. That is, the valve member 134 of the valve unit 130 may block the connection hole 132b of the valve body 132 (corresponding to a misaligned state wherein the connection hole is perpendicular to the communication hole).

Next, in order to use the molded container 100, the handle part 136 provided at the bottom of the valve member 134 in the valve unit 130 is operated and rotated at a predetermined angle by the user. Herein, due to rotation of the handle part 136, the valve member 134 connected to the handle part 136 is also rotated.

Following this, due to rotation of the valve member 134, the communication hole 134a of the valve member 134 and the connection hole 132b of the valve body 132 become collinear and pass through each other, thereby enabling the first storage space 111a to be in communication with the second storage space 111b.

In this regard, the contents of the second storage space 111b flow into the first storage space 111a and are mixed with the contents of the first storage space 111a.

If a plurality of second storage spaces 111b is used and the valve unit 130 is also provided in plural number equal to the number of the second storage spaces 111b, and thus, multiple valve units 130 are all operated, all the contents of the multiple second storage spaces may move toward the first storage space 111a and be mixed with the contents of the first storage space 111a.

For instance, a mask pack is present in the first storage space 111a, and liquid or solid phase contents are included in one of the second storage spaces 112b while the other may contain other contents different from those in the above second storage space 112b. In such a molded container 100 as described above, when using the mask pack present in the first storage space 111a, the contents in the second storage spaces 111b may move toward the first storage space 111a and thus be absorbed in the contents of the first storage space 111a, that is, the mask pack.

Further, after pulling and cutting the sticker 124 attached to the cover member 120 to open the opening 122, the contents of the first storage space 111a, that is, the mask pack is brought out slowly through the opening 122 and used little by little while preventing the liquid contents of the second storage space 111b contained in the mask pack from being separated from the mask pack. Accordingly, even when the liquid contents of the second storage space 111b contained in the mask pack drop down, the contents substantially enter the first storage space 111a, thereby preventing the contents from escaping to the outside.

FIG. 11 is a flow diagram illustrating a method for manufacturing a molded container having multiple storage spaces according to one embodiment of the present invention.

Hereinafter, the method for manufacturing a molded container having multiple storage spaces according to one embodiment of the present invention will be described in detail with reference to FIG. 11.

First, among constitutional parts of the molded container 110, the valve unit 130 and the cover member 120 may be prepared using pre-molded products (S100). Among these constitutional parts, the valve unit 130 may include the valve body 132 and the valve member 134 combined with each other, while the handle part 136 may be provided separately. The valve unit 130 is provided in a condition wherein the connection hole 132b of the valve body 132 is blocked by the valve member 134.

Thereafter, a molding process of introducing a raw material (a thin plate member) into a metal mold and forming the molded body 110 through thermal forming or non-thermal forming is included (S110).

In this regard, the non-thermal forming may include a cold forming process of pressing the metal mold under pneumatic pressure.

Herein, the molded body 110 may include multiple storage spaces 111 and at least one connection groove 112.

The connection groove(s) 112 may be molded in a shape corresponding to the bottom of the valve body 132 in the valve unit 130, so that the valve body 132 can be completely sealed to the connection groove 112 when the valve body 132 is bonded to the molded body.

The connection groove 112 of the molded body 110 formed by vacuum forming or press forming after the molding process S110 is subjected to a punching process of forming a coupling hole 113 by punching the connection groove 112 (S115).

In this regard, the coupling hole 113 preferably has a larger diameter than an outer diameter of a coupling protrusion 132c in order to fit the coupling protrusion 132c of the valve body 132 therein.

After the punching process (S115), a process of coupling the valve unit 130 to the molded body 110 is performed (S120).

The coupling process S120 may include: seating the valve body 132 in the connection groove 112 of the molded body 110 formed in the molding process S110 (S121); and coupling the valve body 132 to the connection groove 112 by welding or adhering the valve body 132 to the connection groove 112 using an adhesive to seal the same (S122).

The valve seating process S121 may be conducted by fitting the coupling protrusion 132c of the valve body 132 into the coupling hole 113 of the connection groove 112 when seating the valve body 132 in the connection groove 112.

The valve coupling process S122 may be conducted by welding or adhering the bottom of the valve body 132 to the connection groove 112 using an adhesive to seal the same. That is, the valve body 132 may be coupled with the connection groove 112 through thermal or ultrasonic welding, or otherwise, using an adhesive.

In this regard, in order to fix the valve body 132 in the connection groove 112, at least a first bonding part 112a and a second bonding part 112b must be coupled with the valve body 132 by applying the adhesive to the above bonding parts or welding the same, as shown in FIG. 7.

After the coupling process S120, a process of filling the multiple storage spaces 111 formed in the molded body 110 with the contents is performed (S130). The filling process S130 may fill the multiple storage spaces 111 with corresponding contents, respectively.

After the filling process S130, a process of fixing the cover member 120 on top of the molded body 110 is performed (S140).

The fixing process S140 may fix the cover member 120 on the sealing part 115 formed in the molded body 110 through thermal or ultrasonic welding, in order to seal the multiple storage spaces 111. That is, the fixing process may prevent the contents of the multiple storage spaces 111 from leaking between the cover member 120 and the molded body 110.

After the fixing process S140, a product finishing process of cutting the peripheries of the multiple storage spaces 111 in the molded container 100 including the cover member 120 fixed to the molded body 110 except for a part of the peripheries of the storage spaces, thus forming a final product, is performed (S150).

After the fixing process S150, a process of fitting and coupling a handle part 136 into the bottom of the valve member 134 is performed (S160).

### DESCRIPTION OF SYMBOLS

100: Molded container

110: Molded body

111: Storage space

111a: First storage space

111b: Second storage space

112: Connection groove

113: Coupling hole

115: Sealing part

120: Cover member

122: Opening

124: Sticker

130: Valve unit

132: Valve body

132a: Fitting groove

132b: Connection hole

132c: Coupling protrusion

134: Valve member

134a: Communication hole

136: Handle part

What is claimed is:

1. A molded container having multiple storage spaces, comprising:
a molded body having at least two storage spaces and a molded connection groove to connect the storage spaces adjacent to each other;
a valve unit seated and fixed in the connection groove to allow the adjacent storage spaces to communicate with each other or to prevent the communication; and
a cover member fixed on the molded body to cover and finish the valve unit coupled to the storage spaces and the connection groove.

2. The molded container according to claim 1, wherein the valve unit comprises:
a valve body that has a bottom surface in a shape corresponding to the connection groove and a flat top surface, a connection hole passing through both lateral sides to allow communication between the adjacent storage spaces, and a fitting groove communicating with the connection hole at the bottom; and
a valve having a communication hole rotatably fitted into the fitting groove to block the connection hole or allow communication of the same.

3. The molded container according to claim 2, wherein the valve body further comprises a pipe type member formed at the peripheries of both ends of the communication hole.

4. The molded container according to claim 1, wherein the pipe type member is integrated with the valve body, or is separately provided and then assembled with the valve body later.

5. The molded container according to claim 1, wherein the cover member comprises an opening through which contents of the spaces are taken out, and further comprises a sticker to cover and close the opening.

6. A method for manufacturing a molded container having multiple storage spaces, comprising:
(a) preparing a pre-molded valve unit, a cover member and a plate member;
(b) introducing the plate member into a metal mold to form a molded body after step (a);
(c) punching a connection groove molded in the molded body formed in step (b) to form a coupling hole, into which the valve unit is fitted;
(d) seating and coupling the valve unit in the connection groove of the molded body having the coupling hole formed in step (c);
(e) filling multiple storage spaces formed in the molded body coupled with the valve unit in step (d) with different contents;
(f) when the storage spaces of the molded body are filled with the contents in step (e), welding and fixing the cover member on top of the molded body to close and seal the storage spaces;
(g) cutting the peripheries of the spaces except for a part of the peripheries of the storage spaces to form a final product after step (e); and
(h) fitting a handle part into the valve member to assemble the container after step (f).

7. The method according to claim 6, wherein the step (d) includes:
seating the valve by seating a valve body in the connection groove of the molded body molded in steps (b) and (c), wherein a part of the valve body is fitted into and seated in the coupling hole formed by the punching process; and
coupling the valve by welding (sealing) the valve body seated in the connection groove through thermal or ultrasonic welding.
